(19) United States
(12) Patent Application Publication
(10) Pub. No.: US 2010/0112285 A1
(43) Pub. Date: May 6, 2010

(54) METHODS FOR MANUFACTURING LAMINATE, DEVICE APPLIED HEREWITH, LAMINATE OBTAINED HEREWITH, METHOD FOR ENCASING SUBSTRATES AND ENCASED SUBSTRATE OBTAINED HEREWITH

(76) Inventors: Pieter Decoene, Lendelede (BE); Christof Vandevoorde, Machelen-Zulte (BE)

Correspondence Address: BACON & THOMAS, PLLC, 625 SLATERS LANE, FOURTH FLOOR, ALEXANDRIA, VA, 22314-1176, US

(21) Appl. No.: 12/531,114

(22) PCT Filed: Feb. 28, 2008
(86) PCT No.: PCT/IB08/00443

§ 371 Date: Sep. 14, 2009

(30) Foreign Application Priority Data
Mar. 14, 2007 (BE) BE 2007/0111

(51) Int. Cl. D06N 7/04; B44C 5/04; B32B 38/06

(52) U.S. Cl. 428/141; 156/219; 156/538; 156/220

(57) ABSTRACT

Method for manufacturing laminate that can be applied for encasing substrates, wherein the method comprises at least the step of performing a press treatment with a press element which is provided with protrusions and/or recesses, with the characteristic that at least at the surface of the laminate, a structure of impressions is formed by means of said recesses and/or protrusions, which substantially follows said pattern. The invention also relates to a device applied herewith, a method for encasing substrates and encased substrates obtained herewith.

This invention relates to methods for manufacturing laminate, a device that can be applied herewith, and laminate which can be obtained by means of such methods. The invention also relates to a method for encasing substrates and encased substrates which may have been obtained by such method.

More particularly, the invention relates to a method for manufacturing laminate, of the type which can be applied for encasing substrates and/or is made as a bendable sheet. Laminate which is suitable for encasing substrates has been known as such already for a long time. According to the state of the art, as described, for example, in WO 96/12857, such laminates are made of material sheets provided with resin, which sheets are consolidated by means of a press treatment. The obtained laminate shows a sufficient transformability for encasing substrates. In WO 96/12857, such laminate is indicated as laminate of postforming quality.

In particular, the invention relates to thin, preferably bendable laminate sheets, which still better do not comprise more than 4 material sheets or more particularly are composed of three or less material sheets. Such laminate sheets preferably have a thickness which is smaller than 1 millimeter, and still better is smaller than 0.5 millimeters. Thus, thicknesses of less than 0.3 millimeters, such as 0.2 or 0.1 millimeters, clearly are not excluded.

The encasing of substrates, for example, wood-, metal- or synthetic material-based substrates, is applied, for example, in the production of skirting or other profiles typically used for finishing a floor covering. For examples of encased finishing profiles for floor coverings, reference is made to the international patent applications WO 2006/074824 and WO 96/12857. Further examples of encased profiles which are not necessarily employed as a finishing profile for a floor covering, however, which also may serve for this purpose, are known, for example, from U.S. Pat. No. 3,296,056. In this last-mentioned document, also a method for encasing such substrates is presented. In the encasing process discussed there, an encased profile is formed by forming the laminate around a previously-formed substrate in a continuous process by gradually bending said laminate towards the substrate by means of pressing rollers and gluing it to the substrate in the same process. In this context, further reference is made to WO 2006/110933, in which an improvement to such encasing process is proposed.

However, the prior art laminate still leaves much to be desired. So, this laminate often renders a plastic-like appearance or an artificial feel, although it may be provided, for example, with a visually perceivable pattern representing wood, stone or another, preferably natural building material. The prior art techniques do not permit bringing, during the manufacture of the laminate, possible impressions or other structure into congruence with the visibly perceivable pattern of the laminate. For example, it is known from U.S. Pat. No. 6,375,777 to form impressions in the upper side of laminate with a wood pattern, however, these impressions are solely oriented in the same direction of the wood pattern and further do not show any affinity with the underlying visually perceivable pattern. According to said prior art, the respective impressions are formed by a so-called structure foil situated between the press element, in this case a press belt, and the laminate to be formed. Such structure foils are difficult to align in accordance with the pattern of the laminate and therefore make it difficult to have the structure of the foil coincide in an acceptable manner with the visually perceivable pattern of the laminate. Structure foils are particularly expensive and manufacturing matching structure foil for each visually perceivable pattern and/or for each structure in the production range of a laminate manufacturer, is difficult to implement from an economic point of view, certainly when small batches of laminate with a particular pattern are intended. Moreover, structure foils are a disposable product which needs to be replaced after several production cycles. Further, it is noted that such structure foils often lead to the occurrence of unintended differences in gloss degree, which are present on the surface of the final laminate in an objectionable manner.

According to its first independent aspect, the present invention aims at an alternative method which also allows manufacturing more realistic laminates. Moreover, it is possible that the method of the invention resolves one or more of said disadvantages of the prior art. To this aim, the invention relates to a method for manufacturing laminate, more particularly of the type that can be applied for encasing substrates and/or is made as a bendable sheet, wherein one starts from at least two material sheets and wherein at least one of these material sheets is provided with resin, wherein the method comprises at least the step of performing a press treatment, wherein said material sheets are connected to each other by means of this press treatment in order to form said laminate, wherein the obtained laminate has a visually perceivable pattern at least at one of its surfaces, with the characteristic that at least at the surface of the laminate, a structure of impressions is formed by means of a press element provided with recesses and/or protrusions, wherein said impressions substantially follow said pattern.

The fact that said structure of impressions is formed, whether or not directly, by means of the press element, opens many new possibilities. Such press elements usually are made of metal, such as steel or aluminum, or of synthetic material, whereby they may have a rigidity that is significantly higher than the rigidity of a structure foil. They may be made, for example, as a press plate, press belt or press roller and may, for example, be oriented in a more simple manner in respect to the visually perceivable pattern of the laminate and/or in respect to the components of such laminate. This allows for that the impressions obtained in the surface of the laminate substantially follow said visually perceivable pattern. Said protrusions and/or recesses of the press element may be formed, for example, in case such press element is made of metal, by etching or by a machining treatment.

It is noted that in case the method of the invention is applied for manufacturing laminates intended for finally producing encased profiles which are applied for finishing a laminate floor or other laminate panels, simply the same press element, or a portion of the same press element, might be used in the production of said laminates as in the production of said floor panels or other laminate panels. In this manner, the finally obtained encased profiles may show a structure matching the laminate floor or any other laminate panel pressed with the same press element or with the same respective portion thereof. This possibility may render the method very economical, as producing a separate press element for manufacturing the laminate may be redundant.

Preferably, said visually perceivable pattern relates to a printed pattern, which is provided, for example, on at least one of said material sheets. Such material sheet forms a so-called decor layer.

Preferably, said structure of impressions is formed during said press treatment. It is clear that preferably only one press treatment is applied for connecting the respective material sheets and providing said structure. However, the present invention does not exclude that several press treatments might be applied.

Said structure can be formed directly by means of said protrusions and/or recesses which are present on the press element, for example, on the press plate. This means that the press plate, or at least the respective protrusions and/or recesses, during forming of the impression, form a direct contact with the respective surface of the laminate, or the components thereof which have to be connected. Direct contact between the press element and the surface of the laminate enhances the transfer of heat and force between the press element and the laminate, and this direct contact also enhances the accuracy and/or subtlety with which the structure of the press element can be copied into the respective surface of the laminate.

The laminate obtained according to the method of the present invention can be composed in a variety of manners. Preferably, said two material sheets of the laminate comprise at least a so-called decor layer showing at least a portion of said visually perceivable pattern. The laminate may also comprise at least one core layer, which is intended for forming the underside of the laminate or at least is intended to be present beneath a portion of the visually perceivable pattern. Such core layer may be realized, for example, by means of a paper sheet, whether or not provided with resin, wherein this paper sheet is relatively heavy and, for example, prior to the resin treatment has a weight of more than 100 grams/m². In German, such paper sheet also is denominated “Kraftpapier” (kraft paper). Further, the laminate may also comprise at least one material sheet extending at least partially on top of said visually perceivable pattern as a translucent or transparent protective layer. Such material sheet preferably comprises abrasion-resistant particles, such as aluminum oxide, or any other, preferably particle- or fiber-shaped, ceramic and/or mineral material. This type of material sheet is known better under the denomination of “overlay”. In the absence of a material sheet of this type, certainly in the case of laminates intended for use in floor applications, preferably still a protective layer with abrasion-resistant particles is provided. This protective layer then can be provided on the visually perceivable pattern in liquid form, for example, can be provided on the decor layer.

Each of said material sheets, decor layer, core layer and/or protective layer may relate to paper layers and/or either can or can not be provided with resin before the production of the laminate, i.e., before said press treatment is performed. According to the invention, at least one material sheet, for example, said decor layer and/or said protective layer, is provided with resin and preferably even impregnated with resin. Preferably, an amount of resin, which is at least equal to the initial resin-untreated weight of the respective material sheet, is provided on and/or in this material sheet. Still better, at least one of the material sheets, for example, said core layer, is free of resin before the press treatment is performed, or this material sheet at least is maximally provided with an amount of resin, the weight of which is smaller than the initial resin-untreated weight of the respective material sheet. By the combination of resin-treated material sheets and resin-untreated or less treated material sheets, the flexibility of the final laminate can be influenced. A heightened flexibility can be desirable when, starting from the obtained laminate, encasing a substrate and/or winding up the obtained laminate. The flexibility, for example, may be such that the obtained laminate can be wound up with a radius of less than 25 centimeters of even less than 15 centimeters and/or that it can be used for encasing substrates of which the surface to be encased has arcuate portions with radii smaller than one centimeter and still better smaller than six millimeters, or smaller than or equal to 4 millimeters.

According to an important preferred embodiment of the present invention, said press treatment is performed by means of a cyclically-operated press, more particularly by means of a short-cycle press, better known under the denomination of “Kurztaktpresse”. In such presses, the material to be pressed is brought between the press elements, after which the press closes, or in other words, the press elements relatively move towards each other and the press elements bring said material to a temperature and/or under pressure. In prior art, cyclically-operated presses are applied, for example, for coating wood-based panels with laminate. In such case, the wood-based panel, for example, an MDF or HDF (Medium Density Fiberboard or High Density Fiberboard) panel, together with the layers of the laminate to be pressed, is brought into the press. A usual thickness for such entity to be pressed is 3 to 15 millimeters. For an example of such short-cycle press, reference is made to the patent document DE 103 19 432. Up to now, it has not been known to apply a short-cycle press for manufacturing laminates of the above-mentioned type. Rather, as in said U.S. Pat. No. 6,375,777, continuous presses were used for manufacturing laminate of this type. However, the inventors surprisingly have found that a cyclically-operated press or a short-cycle press may be used in an excellent manner for manufacturing laminates of the above-mentioned type. By means of such cyclically-operated press, these laminates either can be or can not be provided with a structure of impressions, which substantially follow the visually perceivable pattern. With such short-cycle presses, it is simpler to adjust, for example, the pressing plate than it is the case with aligning the pressing belt and/or the structure foil in continuous presses. It is noted that laminates, which are suitable for encasing substrates, preferably have a thickness that is smaller than 1 millimeter, and still better is smaller than 0.5 millimeters. Thus, thicknesses smaller than 0.3 millimeters, such as 0.2 or 0.1 millimeters, clearly are not excluded. Preferably, such laminate is substantially or practically entirely composed of resin and said material sheets, which latter preferably concern paper sheets. Preferably, the laminate is free from metallic layers and/or free from wood-based layers, such as an MDF or particle board layer. Anyhow, it is preferred that no other structural layers than paper layers are present in the laminate and/or that no more than four material sheets are applied. Still better, three or less material sheets are applied in view of obtaining an acceptable bendability of the laminate in a simple manner.

Said material sheets may be supplied to the press treatment in various manners.

According to a first possibility, at least one of said material sheets can be supplied to said press treatment in the form of a material web, which, for example, is unwound from a roll. The inventors have found that this method can be combined very well with the above important preferred embodiment. Of course, it is not excluded that several material sheets are unwound and/or are supplied as a web to the press device.

According to a second possibility, at least one of said material sheets can be supplied as a, whether or not loose, separate sheet to said press treatment. This method is applicable for continuous presses as well as for cyclically-operated presses or short-cycle presses. Of course, it is not excluded that several material sheets are supplied as, whether or not loose, separate sheets to said press treatment.

According to a preferred embodiment, the above two possibilities are combined, wherein preferably said material sheet, which is supplied as a separate sheet, is transported via said material sheet supplied in the form of a material band or material web towards the press treatment and/or at least is put on this material band, or at least is put onto a portion of this material band. This may be performed, for example, by supporting the separate sheet, or possibly several separate sheets, by means of said material band. It is also possible that the one material sheet, whether or not temporarily, is adhered to, for example, onto the other by means of techniques, such as ionization of the material sheets or bands and/or spot welding, wherein the material sheets or bands already are interconnected at several points by curing the resin present at these spots. For further information on the technique of ionizing, which is known as such, reference is made to GB 1,501,171.

In a practical embodiment of the above preferred embodiment, the laminate consists at least of a core layer and a decor layer, wherein the core layer is supplied in the form of a material band, for example, as from a roll, to the press treatment, whereas the decor layer can be supplied to the press treatment as a separate sheet. Herein, the decor layer can be put or stacked onto said core layer. Further, the laminate may also comprise a protective layer, which then, for example, is also fed to the press treatment as a separate sheet by stacking it onto said decor layer. Both material sheets, decor layer and protective layer, may then be supplied to the press by means of the material band formed by the core layer. In this practical example preferably at least the decor layer is provided with resin, whereas preferably the core layer is free from resin before undergoing the press treatment. In any case, when combining said two possibilities, it is preferred that the material sheet forming the material web is not provided with resin, or at least is provided with a considerably smaller amount of resin than the separate material sheet.

Typical resin-untreated weights of the aforementioned material sheets are for a core layer between 100 and 200 or even up to 300 or 400 gram/m², for a decor layer between 65 and 85 or even up to 100 gram/m², and for a protective layer, or overlay, between 15 and 50 gram/m², or still better between 20 and 30 gram/m². It is clear that the invention is not restricted to material sheets with such resin-untreated weight. For example, it is not excluded that the decor layer shows the typical weight of a core layer or a protective layer, or vice versa. As aforementioned, the material sheets preferably respectively relate to paper sheets. In the case of the protective layer, this may relate to very pure alpha-cellulose paper which, after pressing, becomes transparent or at least translucent.

As aforementioned, the obtained laminate possibly, after the press treatment has been performed, may be wound, for example, on a roll. This is possible in that at least one of said material sheets is made as a continuous material band. This possibility is very convenient for storing the laminate. Also, wound laminate is easier to employ in an encasing process. Surprisingly, the inventors have found that such laminate can also be obtained when, as in the above important preferred embodiment, a cyclically-operated press or short-cycle press is used. In order to obtain smoothly windable laminate, it is recommended to provide at least one of the material sheets, for example, said core layer, not or practically not with resin.

Preferably, the method also comprises at least the step of relative alignment of said press element in respect to said visually perceivable pattern. Preferably, such alignment is considered at regular points in time and is performed, if necessary; for example, such alignment, in the case that a cyclically-operated press or short-cycle press is used, can be performed after a fixed number of cycles, for example, can be considered and/or performed at every cycle. By “considered” in the above is meant that it is seen whether the alignment is still sufficient or must be adjusted. It is clear that such alignment provides for that the extent to which said impressions follow said pattern remains constant or approximately constant.

Said step of relative alignment may comprise at least adjusting said press element. Such adjusting preferably relates to shifting the press element laterally, this is transverse to the transit direction. However, it is not excluded that the press element is shifted in the transit direction and/or that a rotational movement substantially around the normal axis of the respective press element is performed.

Said step of relative alignment may also comprise, whether or not in combination with adjusting the press element, at least adjusting at least one of the material sheets supplied to the press treatment. Preferably, this relates to adjusting at least the possible decor layer. In the case that at least one of said material sheets in the form of a material band or material web is supplied to the press treatment, said adjustment of at least one of the material sheets may be performed at least by turning and/or displacing said material band.

In said step of relative alignment, at least sensors, such as cameras, may be applied, which preferably inspect said visually perceivable pattern.

Said visually perceivable pattern may comprise, for example, marks, which are used for performing said step of relative alignment. Such marks may be situated in the final pattern of the laminate as well as in a waste zone of this laminate.

Said visually perceivable pattern may substantially consist of a wood pattern, wherein said structure then preferably consists of impressions or protrusions at the height or, and/or substantially coinciding with, the depicted wood pores and/or wood nerves. Laminate with such pattern in many cases can be applied for forming encased profiles matching, in respect to appearance as well as in respect to structure, for example, panels with wood decor, such as laminate panels.

Other visually perceivable patterns with matching structures are not excluded. Thus, for example, also stone patterns or fantasy patterns can be represented.

The structure of impressions may also be so fine that it determines the gloss degree of the surface of the laminate. Thus, the present invention may also be applied for manufacturing laminate, wherein said structure comprises at least two areas with differing gloss degrees. This may be of importance, for example, with visually perceivable patterns relating to stone patterns, as well as with certain wood patterns, such as a pattern representing the African dark wood species Wengé. Said difference in gloss degree preferably is 10, as measured according to DIN 67530.

According to its independent second aspect, the invention also relates to an alternative method for manufacturing laminate of the above-mentioned type, wherein one starts from at least one material sheet, wherein the method comprises at least the step of applying a substance in liquid form and solidifying this substance in order to form at least a transparent or translucent layer on top of said material sheet, and wherein the method also comprises the step of forming a structure of recesses and/or protrusions in said transparent or translucent layer, with the characteristic that at least a portion of said structure is formed by exposing said substance to a chemical agent, while this substance already has hardened or has not. Forming a structure in a chemical manner as such is known for floor panels, for example, from US 2006/0150557, however, up to now it was not known to apply such techniques when manufacturing laminate of the above-mentioned type. Anyhow, it is particularly interesting in this specific case. In comparison to a method in which a press element is used for forming the structure, the method of this third aspect may lead to a still more efficient and/or more economical production procedure, in which it is even not necessary to use a press device. Preferably, by means of said solidified substance, at least a portion of the final surface of the laminate is formed. In order to obtain a sufficiently scratch- and wear resistance, hard particles may be added to this substance.

Preferably, the obtained laminate has a visually perceivable pattern at least at one of its surfaces, for example, a wood pattern or a stone pattern. Such pattern may be provided, for example, as a print on said material sheet.

The obtained structure, just as it is the case with the laminates obtained by the method of the first aspect, may substantially follow said pattern. By such method then said disadvantages of the prior art, or at least a portion of these disadvantages, can be remedied, too.

Said substance may be a lacquer, such as an UV-curing or electron beam-curing lacquer.

The exposure of said substance to said chemical agent may lead, for example, to a chemical reaction between the substance and the chemical agent, by which said structure is obtained. Another possible interaction between the substance and the chemical agent is, for example, a repelling or attracting action between the two, as a consequence of which zones can be formed at the surface of the laminate, in which a larger or a smaller amount of said substance is situated. Still another possibility for said interaction may consist at least partially of exerting a promoting or reducing influence on the curing result and/or on the curing speed of said substance by means of said chemical agent. This is, for example, a promoting or reducing influence of the chemical agent on the curing of the substance. As aforementioned, all these interactions are possible while said substance is in the liquid condition as well as when it is in the already solidified condition.

Said chemical agent may be provided, for example, by means of a print process, which preferably is performed on said material sheet or at least is performed at least such that it finally can come into contact with said substance, the latter either being solidified or not. Herein, the chemical agent may be situated between the material sheet and the substance as well as on top of said substance, at the surface of the final laminate.

It is noted that the present invention also relates to laminate of the type that can be used for encasing substrates, with the characteristic that it is obtained or can be obtained by means of a method according to said first or the second aspect of the invention.

By the method described in the first and the second aspect, the inventors can meet the already long-prevailing need of providing laminates of the above-mentioned type with matching structure. Therefore, the invention according to a third independent aspect also relates to laminate of the above-mentioned type, wherein this laminate comprises at least two material sheets and has a visually perceivable pattern at least at one of its surfaces, with the characteristic that at least at one side of the laminate, a structure of impressions is present which substantially follow said pattern. Preferably, the laminate also comprises solidified resin or another solidified substance, wherein then said impressions can be formed. It is clear that the laminate of this third independent aspect can be manufactured by means of a method according to the first or the second aspect. However, according to this third aspect it is not excluded that the impressions are formed in another manner than by means of recesses and/or protrusions, which possibly may be present on the press element and/or may be formed in another manner than by means of a chemical agent. So, for example, they may be formed by means of a structure foil. Further characteristics of the third aspect, of course, may be derived from the preceding and the further introduction in respect to other aspects, as well as from the detailed description, and such independently from the manner in which such laminate is manufactured.

According to a fourth independent aspect, the invention relates to laminate of the above-mentioned type, wherein this laminate is web-shaped, either is wound or not, and has successive sections with a visually perceivable pattern and/or a structure in its longitudinal direction, with the characteristic that the visually perceivable pattern and/or the respective structure is interrupted by strips extending at least in the transverse direction of the laminate. Laminate having such interruptions of the pattern and/or the structure is easier to manufacture than laminate with a continuous pattern and/or structure, however, nonetheless remains applicable as an encasing material. The interruptions can be detected and possibly be used for controlling the encasing process. Herein, preferably at least said strips are considered waste, whereas said sections at least partially are used for encasing substrates. According to a deviating variant of the laminate of this fourth aspect, the laminate, instead of sections with a visually perceivable pattern, has sections with a uniform color. Such uniform color may be provided in any manner, for example, by printing a material sheet or providing it with a coloration.

It is clear that at least one of the aforementioned material sheets may relate to a decor layer that is provided with a printed pattern or coloration. Preferably, said decor layer or at least said printed pattern or said coloration is omitted at the height of said strips. For manufacturers of coated panels, such as laminate panels, decor layers in separate sheets are standard available. Thus, for them this embodiment of the laminate of the invention is easy to manufacture by means of available and/or surplus material. Thus, in many cases, of course, this will be cheaper than having manufactured separate decors or decor layers for manufacturing laminate matching the produced covered or laminated panels.

The decor sections preferably have a length of minimum 1 meter or still better minimum 2 meters, whereas the strips preferably have a length of minimum 5 centimeters or still better minimum 10 centimeters. The width of such web-shaped laminate may be restricted, for example, to 65 centimeters, however, may also be wider, but preferably is restricted to a maximum of 2 meters. Said strips herein preferably extend over the entire width of the web.

Said dimensions of the web-shaped laminate, the decor sections and the interrupting strips simplify the manufacturing process of laminate to a large extent, whereas the dimensions of the decor sections still remain usable for manufacturing the most frequently used encased substrates. For example, such laminate may be manufactured by means of a method according to the first aspect, and in particular may also be manufactured by means of a cyclically-operated press or short-cycle press, wherein then preferably respectively one decor section per cycle is pressed. It is noted that when such press is applied, possible components of the laminate, upon which no pressure is exerted, but which nevertheless are situated in the immediate vicinity of the press, are heated by means of the radiant heat from the press. Such heating without the exertion of pressure may lead to air inclusions or so-called porosity, which manifests itself as a white sheen in the final product. By providing said strips, these undesired side effects are concentrated in waste zones. Thus, in a preferred embodiment, the invention according to its third aspect relates to laminate wherein said strips comprise air inclusions.

In the thickness direction of the laminate, said sections may be composed from a number of material sheets differing from said strips, wherein said strips preferably comprise less material sheets seen in thickness direction. Thus, for example, a possible decor layer may be omitted in the strips. Such web-shaped laminate may be manufactured, for example, by feeding the decor layers as separate sheets to the press treatment, whereas at least one other material sheet, for example, a core layer, is fed to the press treatment as a continuous material web or material band, which, for example, is unwound from a roll. Herein, the decor layers then respectively may be stacked with a certain intermediate space onto the other unwinding material sheet. Possibly, also a protective layer may be provided, which either may be unwound and thereby may form the upper side of the entity of decor sections and strips, or may be provided as a separate sheet, which then is stacked on the decor layer and substantially forms the upper side of the decor sections.

It is clear that such decor sections, which are interrupted by strips, also may be provided on a material sheet by means of a printing process, wherein the printed pattern is interrupted at the height of the strips, whether entirely or partially. It is noted that it is not excluded that the strips also show a visually perceivable pattern, which then preferably differs from the pattern of the decor sections.

According to a fifth independent aspect, the invention also relates to a device allowing to perform the method of the first aspect and/or to manufacture, for example, the laminate of the third and/or of the fourth aspect. To this aim, the invention relates to a device for manufacturing laminate of the aforementioned type, wherein this laminate consists of at least two material sheets, wherein said device comprises at least three partial devices intended to be passed through successively by the laminate or its components, amongst which a first partial device by which the respective material sheets can be applied on top of each other, a second partial device relating to a press device by which the respective material sheets can be connected to each other by means of a press element, and a third partial device by which the obtained laminate can be removed from said press device and possibly can be stored, with the characteristic that said second partial device comprises at least a press device of the cyclically-operated press or short-cycle press type, more particularly of the “Kurztakt” press type.

As aforementioned, the inventors surprisingly have found that a short-cycle press or cyclically-operated press is suitable for manufacturing laminate of the type that can be applied for encasing substrates. However, for obtaining an efficient and economical process, it is recommended to provide such short-cycle press with suitable further partial devices, which then, as aforementioned, are particularly attuned for treating and/or processing such laminate or the components thereof. Such devices, which are composed of at least, one the one hand, a cyclically-operated press or short-cycle press as second partial device and, on the other hand, a first and third partial device for treating laminate or its components, are not known from the state of the art and have an inventive character.

Preferably, said first partial device has at least one unwinding station for unwinding one of said material sheets, which then can be provided as a roll. This material sheet may relate, for example, to a core layer and possibly may be fed to the press device as a continuous material web or material band.

Preferably, said first partial device comprises at least one so-called deposit station for depositing at least one of said material sheets, which then can be provided as separate sheets. This material sheet may concern, for example, the decor layer and/or the protective layer. Depositing then may take place, for example, on said unwound material sheet or core layer forming a material web, material band or other carrier structure.

Said third partial device may comprise at least a winding station for winding the obtained laminate. It is clear that providing the possibility of winding the obtained laminate is advantageous in respect to keeping it in store and to processing it. Moreover, the inventors surprisingly have found that such winding station can be useful in combination with a cyclically-operated press or short-cycle press.

Said first partial device and/or said third partial device preferably comprise at least alignment means allowing to align at least one of said material sheets, for example, a possible decor layer, in respect to the press element. It is clear that by means of such alignment means, for example, a laminate can be manufactured having a structure of impressions following substantially or exactly a visually perceivable pattern of the laminate.

It is possible that said alignment means at least allow that said material sheet can be displaced at least over a portion of its length transverse to the transit direction. It is also possible that the alignment means allow that said material sheet is subjected to a turning movement.

Said winding station and/or unwinding station may at least be laterally displaceable, i.e. transverse to the unwinding or winding direction of the laminate or the components thereof, wherein their respective lateral position preferably can be controlled. Thus, said alignment means preferably may consist of said at least laterally displaceable and possibly controllable unwinding station and/or winding station. Possibly, also only a portion of the respective station may be made displaceable and/or controllable. Thus, for example, for displacing such material sheet at least laterally or transverse to the transit direction of the material sheets, one may also work with rolls or rollers provided especially for this purpose. It is noted that the unwinding station and/or the winding station, or the respective concerned displaceable portions thereof, also may allow for a turning of said material sheet; preferably, this relates at least to a turning in the plane formed by the respective material sheet.

Also, whether or not in combination with displaceable and/or controllable winding and/or unwinding stations, said partial device may comprise alignment means by which said press element may be aligned in respect to at least one of said material sheets. Preferably, the press element is at least laterally displaceable, i.e. transverse to the unwinding or winding direction of the laminate or the components thereof. Also, a turning and/or a displacement of the press element in the unwinding or winding direction of the laminate is not excluded.

Preferably, said press device, which forms part of the second partial device, relates to a cyclically-operated press or short-cycle press having at least one dimension, for example, the length thereof, of between 2 and 3 meters. Very suitable for manufacturing laminates that can be used for manufacturing encased skirting or other slim profiles is a length of approximately 2.8 meters. For the width, one may work with a dimension that is larger than 40 centimeters, and still better is larger than 60 centimeters. This width of laminate sheets is sufficient for the most encasing applications. According to the invention, it is also possible to work with wider presses. Possibly, in a wider press also two or more laminates may be manufactured in parallel. Also, multi-daylight presses are possible, in which then several laminates may be manufactured above each other, although single-daylight presses are preferred.

According to a sixth independent aspect, the present invention relates to a method for encasing substrates, with the characteristic that for encasing, one starts from a laminate which is web-shaped, whether or not wound up, and having in its length direction successive sections with a visually perceivable pattern and/or a structure, wherein said visually perceivable pattern and/or the respective structure is interrupted by strips extending at least in the transverse direction of the laminate.

It is clear that in such method, for the laminate, for example, the laminate with the characteristics of the fourth aspect can be applied.

In the method of the sixth aspect, use can be made of the presence of said strips in a beneficial manner. They may be detected, for example, by means of cameras or other sensors, and this detection may be used as a control signal in the encasing process. This makes it possible, for example, to orient the visually perceivable pattern each time in the same manner in respect to the substrate. Thus, this preferably relates to an alignment in the longitudinal direction of the substrate. Thus, it may be desirable, for example, when forming an encased skirting or another slim profile, that characteristics depicted in the pattern of the laminate, such as, for example, cement joints or other transitions, occur at well-defined locations in the longitudinal direction of the skirting or just do not occur in well-defined zones in this longitudinal direction.

It is clear that, according to a deviating variant of the sixth aspect, one may also work with a uniform color instead of a pattern.

Preferably, the feeding of said web-shaped laminate and the feeding of the substrates to be encased is performed in a synchronized manner. Thus, they may, for example, be synchronized in such a manner that the respective substrate is encased with a portion of the laminate that is free of said strips. Also, it is possible to synchronize in such a manner that said strips are applied only on portions of the substrate which subsequently are to be removed, such as on the extremities of the substrate or on the locations where the substrates must be sawed or must be divided in any other manner.

As aforementioned, such method, for example, can be applied for manufacturing skirting and other finishing profiles for floor coverings. However, it can also be applied for manufacturing profiles for any application, such as, for example, for manufacturing profiles which are suitable for finishing furniture. Preferably, this, independently from the application, relates to slim profiles, the length of which is at least 5 times and still better at least 10 times the width and/or height of the cross-section.

It is clear that the present invention also relates to such encased substrates. They are characterized in that they are obtained by means of a method according to the sixth aspect, and/or that they are encased with a laminate with the characteristic of the third and/or the fourth aspect.

With the intention of better showing the characteristics of the invention, hereafter, as an example without any limitative character, several preferred embodiments are described, with reference to the accompanying drawings, wherein:

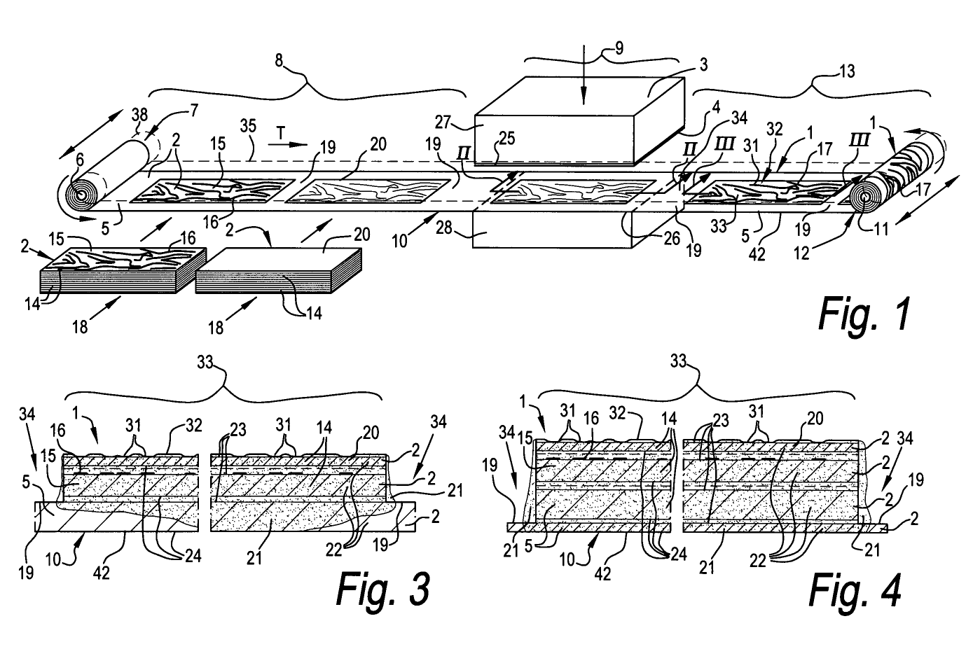

FIG. 1 in perspective shows a method with the characteristics of, amongst others, the first aspect of the invention and in which a device with the characteristics of, amongst others, the fifth aspect is applied;

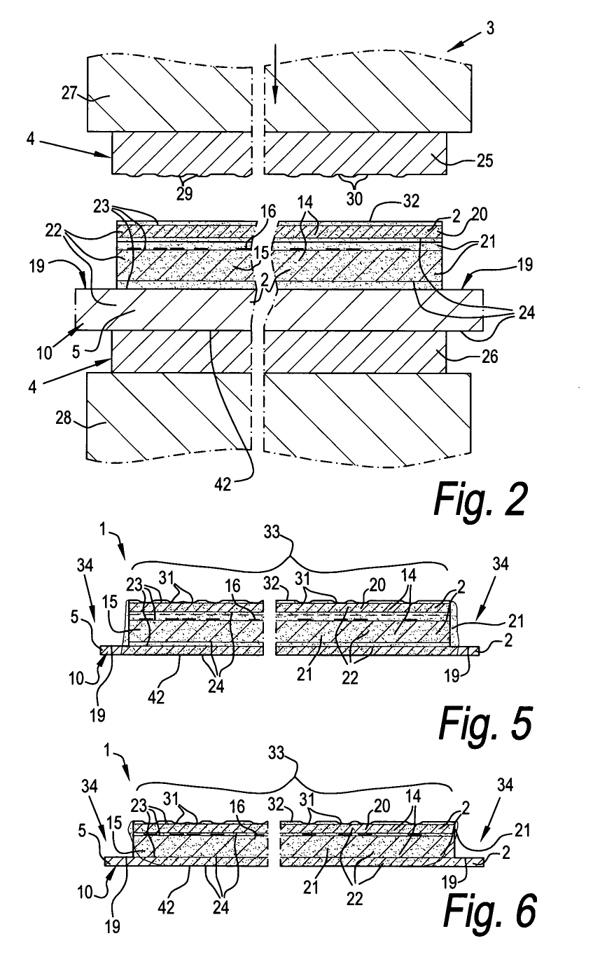

FIG. 2 represents a view according to the cross-section indicated by line II-II in FIG. 1;

FIG. 3 represents a laminate with the characteristics of the present invention in a view according to the cross-section indicated by line III-III in FIG. 1;

FIGS. 4 to 6, in a view similar to that of FIG. 3, show variants of such laminate;

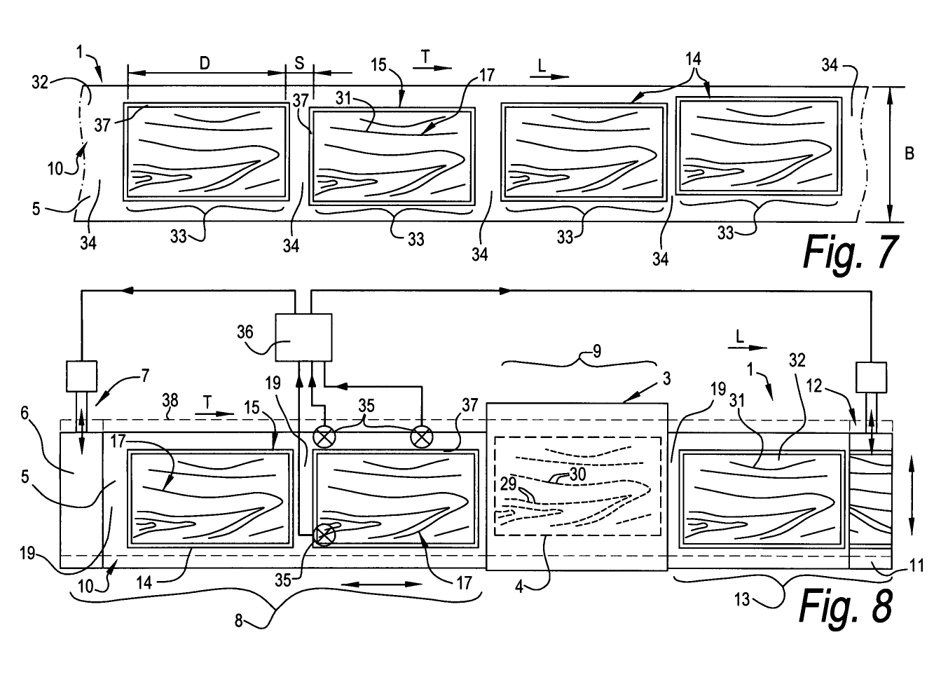

FIG. 7 in top view shows a strip of laminate with the characteristics of the present invention;

FIG. 8 in top view shows a device with, amongst others, the characteristics of the fifth aspect of the invention;

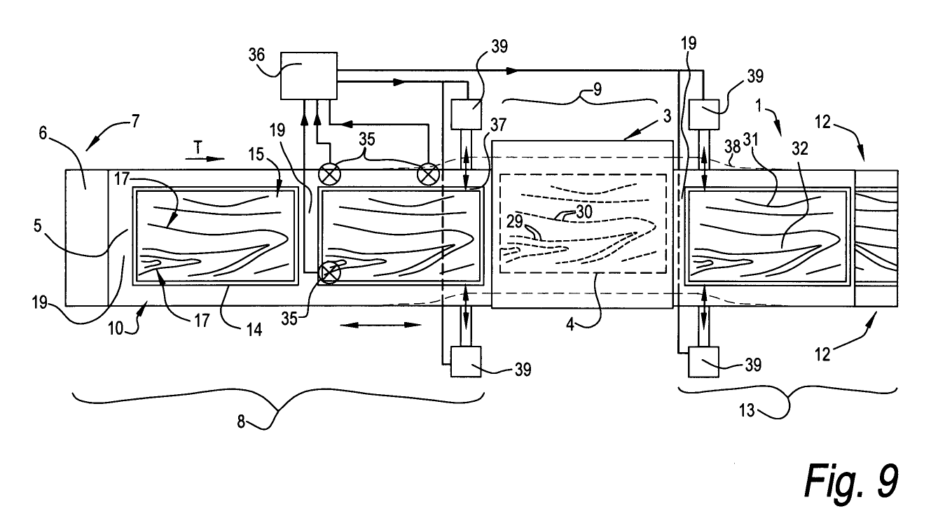

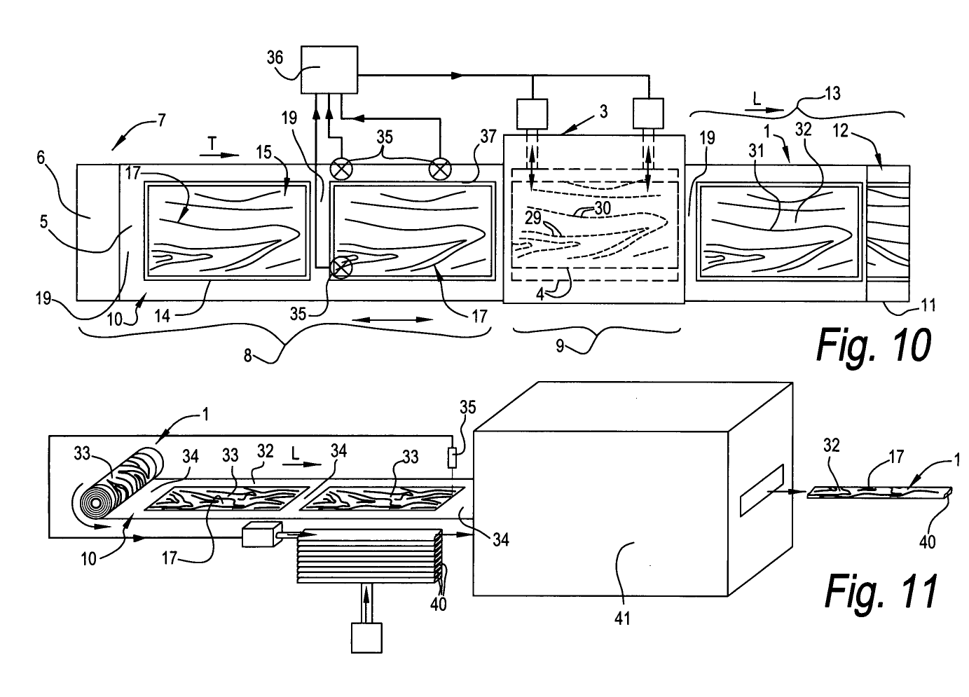

FIGS. 9 and 10, according to a similar view as FIG. 7, show variants of such device;

FIG. 11 in perspective shows a device for encasing substrates with, amongst others, the characteristics of the sixth aspect of the present invention;

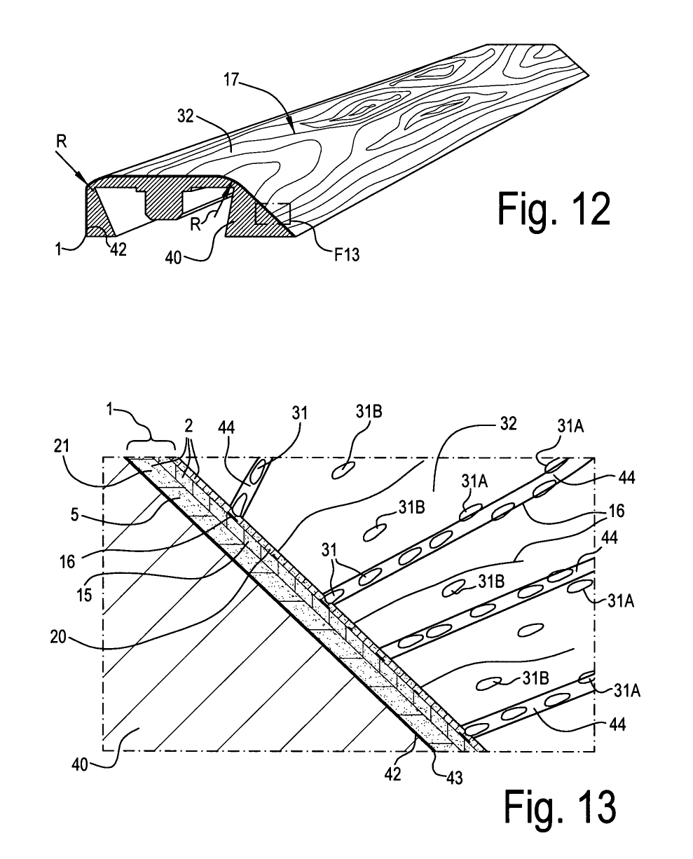

FIG. 12 in perspective shows an encased substrate with the characteristics of the invention; and

FIG. 13, at a larger scale, shows a view onto the region indicated by F13 in FIG. 12.

FIG. 1 somewhat schematically represents a method for manufacturing laminate 1. Herein, one starts from at least two material sheets 2, in this case even three material sheets 2, which are fed to a press device 3 and are connected to each other by means of a press treatment performed with said press device 3. To this aim, the method of the invention comprises at least the step of performing a press treatment by means of a press element 4.

As aforementioned, the laminate 1 of the example is manufactured starting from three material sheets 2, in this case, paper sheets.

A first material sheet 2 concerning a core layer 5, or so-called “kraft paper”, is fed to the press treatment as a continuous material web. To this aim, this material sheet 2 in the example is unwound from a roll 6. Herein, the unwinding station 7 applied therein forms part of a first partial device 8 situated in the transit direction T of the laminate 1 or its components 2 upstream from the press device 3, which in its turn forms a second partial device 9, and by which the three respective material sheets 2 can be provided on top of each other. Herein, this unwinding station 7 may be situated up to 10 meters or more upstream from the press device 3. The respective material sheet 2 supplied from a roll 6, in this case, a core layer 5, herein may retain the shape of an uninterrupted material layer or material web up to the press device 3 or, as represented, even up to downstream from the press treatment 3, which material web then may form a carrier structure 10 for at least one or all remaining material sheets 2 of the laminate 1 to be manufactured. In this case, the material sheet 2-5, together with the connected thereto remaining material sheets 2, or in other words the obtained laminate 1, is wound on a roll 11 again by means of a winding station 12 forming part of a third partial device 13 situated, in the transit direction T of the laminate 1 or the components thereof, downstream from the press device 3 or second partial device 9, and with which the obtained laminate 1 can be removed from said press device 3 or second partial device 9. According to the invention, however, it is clearly not excluded that this unwound material sheet 2-5 is cut, for example, into separate sheets 14 upstream, in or downstream from the press device 3 or second partial device 9.

A second material sheet 2 relates to a decor layer 15 comprising a print 16, which print is intended to form at least a portion of a visually perceivable pattern 17 of the final laminate 1. As represented, this decor layer 15 respectively can be provided as a separate sheet 14. To this aim, use is made of a deposit station 18 forming part of said first partial device 8. In this case, these separate sheets 14 are directly laid upon the material web or carrier structure 10 formed by said unwound first material sheet 2-5. As depicted, a whether or not constant intermediate space 19 may be left between two successive decor layers 15. One may also work with adjoining or almost adjoining decor layers 15, or possibly with overlapping decor layers 15. The decor layer 15 may be transported to the press device 3 by means of the material web 10 formed by said unwound first material sheet 2-5. In order to promote the efficiency of the transport, the decor layer 15 possibly, whether or not reversibly, may be interconnected with said web 10, for example, by means of an ionization and/or welding device, which devices are not represented in the figure.

A third material sheet 2 relates to a protective layer 20 or overlay, which possibly may comprise hard particles and is intended for being present in the final laminate 1 on top of said visually perceivable pattern 17. This material sheet 2, too, respectively may be provided as a separate sheet 14 by means of a second deposit station 18, which also forms part of said first partial device 8. These separate protective layers 20 then can be laid upon said decor layers 15. Preferably, per decor layer 15 solely one protective layer 20 is applied. However, it is not excluded that several protective layers 20 are applied on top of or next to each other on one decor layer 15. It is clear that according to the example also this third material sheet 2 can be transported to the press device 3 via said material web or material band 10 formed by the unwound core layer 5, and that this third material sheet 2 also can be adhered at points to said web 10, whether or not permanently, possibly via said decor layer 15.

It is noted that said core layer 5 also can be provided as separate sheets 14 and/or that said decor layer 15 and/or protective layer 20 possibly can be unwound from a roll 6. In a particular preferred combination, for example, one or more core layers 5 as well as one or more protective layers 20 are unwound from a roll 6 and thus fed to the press device 3 as a web 10, whereas at least or only the decor layer 15 is fed to the press device 3 as separate sheets 14.

FIG. 2 shows in cross-section a view in said press device 3 at a point in time at which said material sheets 2 are not yet interconnected, however, already have solely been stacked upon each other. FIG. 2 clearly shows that in the example said protective layer 20 and decor layer 15 are provided with resin 21 and even are impregnated with this resin 21. Preferably, these layers 15-20 are saturated with resin 21, such that they, as represented, are provided with said resin 21 both in their matter 22 as well as at their two surfaces 23-24. In the example, however, the core layer 5 is free from resin 21, or at least comprises substantially less resin 21 than the protective layer 20 and the decor layer 15. Preferably, the amount of resin 21 of this lowermost material sheet 2 is smaller than the maximum amount, or saturation amount, which could be taken up by the respective material sheet 2. This is desirable, for example, when such core layer 5 is fed to the press device in the form of a material web or material band.

The depicted press device 3 relates to a so-called cyclically-operated press or short-cycle press, or more particularly a so-called “Kurztakt” press. As represented, the stacked material sheets 2 are brought between an upper press element 25 and a lower press element 26, in this case plate-shaped press elements or press plates. These press elements 25-26 are respectively mounted or held against an upper heating plate and a lower heating plate (German: “Heizplatte”). FIG. 2 also clearly shows that the upper press element 25, or the upper press plate, is provided with protrusions 29 and/or recesses 30. Then, a structure of impressions can be formed in the surface of the final laminate 1 by the press treatment, whether or not directly, and according to the example directly, by means of these protrusions 29 and/or recesses 30. We want to point out again that the inventors have found that such cyclically-operated press also can be applied in a useful manner when no structure of impressions has to be formed and/or when possible impressions do not necessarily have to follow said visually perceivable pattern.

Preferably, in the press treatment in a method according to the invention a press temperature of more than 120° C. and preferably even more than 150° C. is reached at the upper press element 25 as well as at the lower press element 26. The applied working pressures preferably are between 20 and 80 bar/cm² and may even vary during a press treatment performed on the same stacks of material sheets 2. Thus, for example, during a first period of, for example, between 15 and 30 seconds, one may work with a working pressure of more than 40 bar/cm², and during a subsequent second period of, for example, between 5 and 15 seconds, may work with a working pressure of less than 40 bar/cm². Seen over the total pressing time required for pressing one stack of material sheets 2, in this time preferably an average working pressure of at least 40 bar/cm² is reached. This pressing time preferably is 15 to 50 seconds and still better between 20 and 40 seconds.

FIG. 3 represents the laminate 1 obtained by interconnecting said material sheets 2 by means of the press treatment and the press elements 25-26. Herein, it is clear that said impressions 31 substantially or even entirely correspond to said pattern 17 or printed pattern or print 16 of the decor layer 15. In this manner, a structure of impressions 31 can be formed at the surface 32 of this laminate 1, wherein the impressions 31 substantially follow this pattern 17.

It is clear that by means of the press treatment it may be obtained that resin 21 of certain material sheets 2 penetrates up into other material sheets 2. For example, FIG. 3 shows that the resin 21 of the protective layer 20 and/or the decor layer 15 has penetrated up into the scarcely resin-treated or resin-untreated core layer 5 and that this resin 21 can perform the adherence to the core layer 5. The inventors have found that even a sufficient adherence can be obtained when in the configuration of FIG. 1, 2 or 3 solely one material sheet 2, for example, the protective layer 20 or the decor layer 15, is provided with resin 21. Preferably, it is provided for that the surface of the resin-treated material sheets 2 is smaller than the surface of the resin-untreated or scarcely resin-treated material sheets 2. Preferably, a resin-untreated or scarcely resin-treated material sheet 2 is applied as a carrier 10 for at least one and preferably all remaining material sheets 2, possibly in the form of an unwound material sheet 2 forming a web 10 on which the respective material sheets 2 then can be laid as separate material sheets 14. In this manner, the risk is minimized that the obtained laminate 1 after pressing will become stuck with its longitudinal edges to the press element 25-26.

FIG. 3 further shows that for the core layer 5, a material sheet 2 is chosen that is heavier, or thicker, than the decor layer 15, which in its turn is chosen such that it is thicker than the protective layer 20. In this case, it has been chosen to make use of the typical weights of such material sheets 2 mentioned in the introduction. In the present case, the core layer 5, as aforementioned, forms the carrier structure 10 for the decor layer 15 and the protective layer 20.

FIG. 4 shows that it is not excluded to apply a thinner carrier structure 10 or material web than this is the case in FIG. 3, wherein the material sheet 2 forming this carrier structure 10, for example, has a resin-untreated weight which is comparable to the typical resin-untreated weight of a protective layer 20.

In general, it is noted that the carrier structure 10 or material web does not necessarily have to form a part of the final laminate 1. This carrier structure 10 may or may not be provided with resin 21. If such carrier structure 10 forms part of the final laminate 1, it preferably forms a core layer 5.

The laminate 1 represented in FIG. 4 comprises four material sheets 2 in total, of which the three material sheets 2 situated closest to the upper surface 32 of the laminate 1, are supplied to the press treatment as separate resin-treated material sheets 14, and the lower material sheet 2 is fed to the press treatment in the form of a material web or material band, preferably unwound from a roll 6.

FIG. 5 shows that it is possible that a thicker core layer 5 is omitted from the laminate 1 of FIG. 4, and that therefore a material sheet 2, whether or not resin-treated, is applied as the sole core layer 5, with a resin-untreated weight which is typical for a protective layer 20. Thus, the laminate 1 represented in FIG. 5 comprises solely three material sheets 2 in total, of which the two material sheets 2 situated closest to the upper surface 32 of the laminate 1 are supplied to the press treatment as separate resin-treated material sheets 14 and the lower material sheet 2 is fed to the press treatment in resin-untreated condition from a roll 6.

FIG. 6 shows that it is possible to apply solely one resin-treated material sheet 2 in the configuration from FIG. 5. In the example of FIG. 6, solely the protective layer 20 was resin-treated, however, by the intermediary of the press treatment, the resin 21 penetrated up into the decor layer 15 and the carrier structure 10, which in this case again is formed by a material sheet 2 with a resin-untreated weight which is typical for a protective layer 20.

It is noted that according to the present invention, it is not excluded that said carrier structure 10 or material web or band is formed by several, whether or not already interconnected, material sheets 2, which then, for example, both are fed to the press treatment from a roll 6. These material sheets 2 may or may not be of the same type. Thus, for example, at least two material sheets 2 with the typical resin-untreated weight of a core layer 5 or a protective layer 20 or a decor layer 15 may be applied.

FIG. 7 represents a web-shaped laminate 1 which can be obtained by a method according to the first aspect of the invention and also shows the characteristics of, for example, the third and/or the fourth aspect of the invention. However, in its longitudinal direction L, this laminate 1 shows successive sections 33 with a visually perceivable pattern 17, in this case, a wood pattern. This visually perceivable pattern 17, however, is interrupted by strips 34 extending in the transverse direction of the laminate 1.

The decor sections 33 preferably have a length D of minimum 1 meter or still better minimum 2 meters, whereas the strips 34 preferably have a length S of minimum 5 centimeters or still better minimum 10 centimeters. The width B of such web-shaped laminate 1 may be limited, for example, to 65 centimeters, however, may also be wider; anyhow, preferably it is limited to a maximum of 2 meters. Herein, said strips 34 preferably extend over the entire width B of the web 10.

From FIG. 7, it is clear that said decor sections 33 do not have to be perfectly aligned, for example, in transverse direction and that said strips 34 do not necessarily always have to show the same length S. Further, it is also possible that the longitudinal direction L of the decor sections 33 forms an angle in respect to the longitudinal direction L of the web 10.

It is clear that the laminate 1 at the height of the strips 34 can be composed, for example, of less material sheets 2. For example, said decor layer 15 may be omitted at that location.

FIG. 8 shows that the method according to the first aspect may also comprise the step of the relative alignment of said press element 4, more particularly the press element which is provided with said protrusions 29 and/or recesses 30, in respect to said visually perceivable pattern 17; preferably, said alignment is performed such that said recesses 29 and/or protrusions 30 of the press element 4 are positioned as effectively as possible in respect to, such as approximately above, the corresponding characteristics of said visually perceivable pattern 17. In the example of FIG. 8, the step of the relative alignment comprises adjusting at least one of the material sheets 2 fed to the press treatment. In this case, the carrier structure 10 or material web is moved via the winding and/or the unwinding station 7-12 in lateral direction, i.e. transverse to the transit direction T. Of course, preferably then the visually perceivable pattern 17 must be moved via this carrier structure 10, for example, in that it is provided on the carrier structure 10 as a separate decor layer 15. It is clear that it is not excluded that the respective material sheet 2, or the respective material web 10, is turned by means of the winding and/or unwinding station 7-12, for example, by laterally displacing these stations 7-12 over a varying distance and/or by turning one or more of these stations 7-12 or respective portions thereof themselves.

To the benefit of the alignment, sensors 35, such as cameras, may be applied, the signals of which possibly are processed by a computing unit 36 and are used for determining and performing the displacement of the winding and/or unwinding stations or the respective portions thereof. To this aim, said visual pattern 17 may comprise marks, for example, in a portion thereof, such as an edge 37, which is considered waste.

It is noted that an alignment step, such as described by means of FIG. 8 and following figures, just as in FIG. 1, is represented by the dashed line 38.

FIG. 9 shows that such adjustment of at least one of the material sheets 2 does not necessarily have to occur by means of the winding and/or unwinding stations 7-12 or portions thereof. This may also take place, as represented here, by means of gripper devices 39, which are situated in the transit direction T of the laminate 1 or the components thereof upstream or downstream of the press device 3.

The arrangement of FIG. 9 allows a fine-tuning of the position of the material sheets 2 in a simple manner other than the lateral displacement of the winding and/or unwinding station 7-12 or portions thereof. It is clear that this arrangement, too, may allow for a turning of the respective material sheet. Possibly, the arrangement of FIG. 9 may be combined with the arrangement of FIG. 8, wherein then preferably a rough adjustment of the respective material sheet 2 and/or the visually perceivable pattern 17 may take place by means of the displacement of the winding and/or unwinding stations 7-12 or respective portions thereof, and fine-tuning may take place by means of said gripper devices 39.

FIG. 10 shows another possibility for realizing said step of relative alignment. Herein, this step comprises at least the adjustment of said press element 4-25.

It is clear that in the FIGS. 8, 9 and 10 a possible alignment in transit direction T may be performed, for example, by winding or unwinding to a greater or lesser extent. Further, it is clear that these ways of alignment also allow rotating the material sheets 2, the press element 4-25, respectively, if necessary, and that these ways may be combined with each other without any limitation.

It is also clear that said alignment step does not necessarily have to take place in a position directly upstream from the press device 3. For example, it may take place as well in the press device 3 as at another position upstream of the press device 3. It is noted that working with a material sheet 2 in the form of a material web or material band 10 renders the possibility of alignment in the press device 3 particularly feasible, as the alignment means, for example, in the form of a gripper device or the winding and/or unwinding stations 7-12 and/or respective portions thereof, may be located externally to the press device 3.

It is noted that the devices 8-9-13, as represented in perspective in FIG. 1 and in top view in FIGS. 7 to 9, show the characteristics of the fifth aspect of the invention.

FIG. 11 represents a method for encasing substrates 40 with the characteristics of the sixth aspect of the invention. Herein, one starts from laminate 1 which is web-shaped and in this case is wound up. In its longitudinal direction L, the laminate 1 has successive sections 33 having a visually perceivable pattern 17 and/or a structure, as this also was the case, for example, in the laminate 1 of FIG. 7. Herein, said visually perceivable pattern 17 is interrupted by strips 34 extending at least in the transverse direction of the laminate 1.

In the example, the feeding of the web-shaped laminate 1 is synchronized with the feeding of the substrates 40 to be encased. This takes place in such a manner that the respective substrate 40 finally is encased by a portion of the laminate 1 that is free from said strips 34. Said synchronization takes place on the basis of a detection of the decor section 33 and/or the strips 34 of the laminate 1. This detection preferably is performed automatically by means of a camera or other sensor 35 and preferably provides a signal which can be applied for feeding the substrates 40 to be encased. It is noted that for the sake of the simplicity of the figures, the encasing machine 41 is represented in a highly schematic manner. For a more detailed example of such machine 41, reference is made to the aforementioned U.S. Pat. No. 3,296,056.

FIG. 12 shows an example of a profile which can be obtained by means of the method of the sixth aspect. As represented, the laminate 1 is adhered with its underside 42 to the substrate 40. This may be performed, for example, by gluing the laminate 1, as aforementioned. For this purpose, for example, polyolefin glues or polyurethane glues may be applied. As represented, substrates having curved surfaces with small radii R also may be encased with laminate 1 in a satisfying manner. These radii R may be, for example, less than 5 millimeters and even less than 3 millimeters. It is noted that in general polyolefin glue allows encasing substrates with smaller radii R than polyurethane glue.

During encasing, the substrate 40 may or may not be already in its final form. However, in most cases at least a finishing treatment of the substrate and the laminate provided thereon may be necessary. In the example, it is even possible that the profile of the not-encased side of the profile is obtained by such finishing treatment.

The substrates 40 which are encased with the laminates of the invention may consist of any material. For example, they may comprise wood-based materials, such as MDF or HDF or plywood, or they may comprise synthetic material or metal, such as aluminum. Such substrate 40 also may or may not be composed of several, possibly separate portions, which then possibly together are encased with laminate 1.

Further, it is possible that more than one laminate 1 is applied for encasing a substrate 40 and/or that the obtained encased substrate is further divided into usable profiles. This possibility is known as such, for example, from WO 2006/110933.

FIG. 13 represents the glue layer 43 and the layered construction of the laminate 1. For the sake of the simplicity of the representation, the material sheet 2 and the possible resin 21 at the surfaces 23-24 of these material sheets 2 respectively are shown as an entity. From FIG. 13, it is clear that the structure of impressions 31-31A substantially follows the visually perceivable pattern 17, in this case by the print 16 of the decor layer 15. Herein, the impressions 31-31A are formed by local impressions located at the height of wood nerves 44 depicted in the pattern 17. Such local impressions 31-31A may emulate, for example, the shape of natural wood pores. Herein, it is not necessary to emulate the exact correspondence in respect to the position between the separate impressions 31 and the wood nerves 44. As illustrated, the impressions 31A may deviate somewhat from the illustrated wood nerves 44, however, a global correspondence may be obtained. It is clear that it is also not excluded that impressions 31B are formed which do not show any correspondence with the pattern 17. The combination of corresponding impressions 31-31A and not corresponding impressions 31B enhances the realistic appearance of the laminate 1. Further, it is clear that the impressions 31-31A-31B do not necessarily have to be performed as local impressions. For example, also oblong impressions or terrace-shaped impressions or any combination of local impressions, oblong impressions and terrace-shaped impressions may be used. For examples of shapes of possible impressions, reference is made to WO 01/96689 and US 2006/0144004, wherein this latter document specifically covers the topic of terrace-shaped impressions.

It is clear that according to all aspects of the invention, said material sheets 2 preferably show the feature that they can not only carry resin 21 at their surfaces 23-24, but also can take it up in their matter. For example, this is the case with paper sheets or textile. Material sheets 2 composed of wood, wood particles or wood fibers are less interesting, and also metal material sheets preferably are banned from such laminate 1.

Further, it is clear that according to all aspects of the invention, not necessarily all material sheets 2 do have to be provided with resin 21 before the press treatment is performed. Also, it is desirable that the respective material sheets 2 forming the final laminate 1, when pressed, indeed all comprise resin 21. Thus, it is possible that during the press treatment the resin 21 flows from the one material sheet 2 to the other material sheet 2 and thereby also a connection between the respective material sheets 2 is obtained.

It is also noted that the possibility of forming laminate starting from at least two material sheets, amongst which at least one that is fed to the press treatment in form of a material web and at least one that is fed as a separate sheet, also represents a particular independent aspect of the invention. Namely, such method opens many new possibilities and, for example, possibly allows shortening the length of a production line because one or more deposit stations for depositing separate sheets possibly may be omitted. According to this particular independent aspect, the invention relates to a method for manufacturing laminate, more particularly of the type that can be applied for encasing substrates 40 and/or is made as a bendable sheet, wherein the laminate 1 is formed by connecting at least two material sheets 2 in a press device 3 by means of a press treatment, with the characteristic that at least one of said material sheets is fed as a continuous material web to and/or through said press device 3, whereas also at least one other of said material sheets 2 is fed to the press device 3 as a separate sheet 14.

Preferably, said separate sheet 14 consists of a so-called decor layer. Preferably, said continuous material layer or material web is applied as a carrier structure 10 with which then said separate sheets 14 can be transported at least into said press device 3. For examples, advantages and further characteristics of this method, reference is made to the introduction and the detailed description, where in particular, amongst others, FIGS. 1, 8, 9 and 10 illustrate non-limiting examples of such method. It is clear that the invention according to this particular independent aspect also relates to laminate 1 formed according to this method.

It is clear that where in the aspects of the present invention a visually perceivable pattern is mentioned, a pattern with lines and/or colors and/or color tints is intended and that a visually perceivable pattern consisting solely of impressions is excluded.

It is noted that where in the above, resin 21 is mentioned, any kind of resin is intended and thus both thermo-hardening and thermoplastic resins are intended. Preferably, amino resins, such as melamine resins, are added. It is possible that these resins further are provided with additives promoting, for example, the flow, solidification or cross-linking of the resin. Also, additives are possible which promote the release of the press element 4-25-26 from the formed laminate. By means of such additives, also the solidification rate of the resin may be modified. Preferably, the resins used in the invention rather are adjusted quite slow, or the resin, in other words, comprises means decelerating the cross-linking or solidification in comparison to a pure resin solution. Preferably, the resin is provided on the respective material sheets in an impregnation process taking place prior to said press treatment and which either may or may not be in line with this press treatment.

Further, it is noted that the underside 42 of the obtained laminate 1 preferably is made substantially flat and that still better no impressions or other structure are present on the underside of this laminate 1.

Highly efficient results may be obtained by means of a method according to the first aspect, when the device applied herewith shows the characteristics of said fifth independent aspect, as it is the case in the example of FIG. 1.

The present invention is in no way limited to the embodiments described by way of example and represented in the figures, on the contrary, such methods and floor panels may be realized according to various variants without leaving the scope of the invention.

1-45. (canceled)

46. Method for manufacturing laminate of the type usable for encasing substrates and/or is a bendable sheet, wherein one starts from at least two material sheets and wherein at least one of these material sheets is provided with resin, the method comprising at least the step of performing a press treatment, wherein said material sheets are connected to each other by means of the press treatment in order to form said laminate, wherein the obtained laminate has a visually perceivable pattern at least at one of its surfaces, wherein at least at said one surface of the laminate, a structure of impressions is formed by means of a press element provided with recesses and/or protrusions, wherein said impressions substantially follow said pattern.

47. The method of claim 46, wherein said visually perceivable pattern relates to a printed pattern or print provided on at least one of said material sheets.

48. The method of claim 46, wherein said structure of impressions is formed during said press treatment by which said material sheets are connected and wherein said press element is a press plate and wherein said structure of impressions is formed directly by means of said protrusions and/or recesses which are present on the press element.

49. The method of claim 46, wherein at least one of said material sheets is supplied or fed to said press treatment in the form of a material band.

50. The method of claim 46, wherein two material sheets comprise at least a so-called decor layer showing at least a portion of said visually perceivable pattern, and wherein said laminate comprises at least one material sheet extending above said visually perceivable pattern as a translucent or transparent layer.

51. The method of claim 46, wherein the method also at least comprises the step of the aligning said press element relative to said visually perceivable pattern and wherein said step of the relative alignment at least comprises adjusting at least one of the material sheets fed to the press treatment.

52. The method of claim 46, wherein said visually perceivable pattern comprises a wood pattern, and wherein said structure comprises impressions or protrusions at the height of and substantially corresponding to the depicted wood pores and/or wood grain.

53. The method of claim 46, wherein said press treatment is performed by means of a cyclically-operated press.

54. The method of claim 53, wherein said cyclically-operated press, instead of being applied for manufacturing laminate with a structure of impressions following the pattern, it is applied for manufacturing any laminate of the above-mentioned type, wherein one also starts from at least two material sheets, wherein at least one of these material sheets is provided with resin, and wherein the method comprises the step of performing a press treatment, wherein said material sheets are connected to each other by means of this press treatment in order to form said laminate, wherein the obtained laminate has a visually perceivable pattern at least at one of its surfaces and wherein a press element with protrusions and recesses either may or may not be used for forming possible impressions in said surface.

55. Laminate of the type usable for encasing substrates and/or is made as a bendable sheet, wherein the laminate comprises at least two material sheets and shows a visually perceivable pattern at least at one of its surfaces, wherein at least at one side of the laminate a structure of impressions is present, which substantially follow said pattern.

56. Laminate of the type usable for encasing substrates and/or is made as a bendable sheet, wherein the laminate is web-shaped and either wound up or not and shows successive sections with a visually perceivable pattern and/or a structure in its longitudinal direction, wherein the visually perceivable pattern and/or the respective structure is interrupted by strips extending at least in the transverse direction of the laminate.

57. Device for manufacturing laminate, wherein this laminate is of the type that is usable for encasing substrates and/or is made as a bendable sheet and comprises at least two material sheets, said device comprising at least three partial devices which are intended for being successively passed by the laminate or its components, said devices comprising a first partial device enabling the respective material sheets to be applied above one another, a second partial device relating to a press device by which the respective material sheets can be interconnected by means of a press element, and a third partial device by which the obtained laminate is removed from said press device, wherein said second partial device comprises at least a press device of the cyclically-operated press type.

58. Method for encasing substrates, wherein for encasing, one starts from laminate which is web-shaped and whether or not wound up and having in its longitudinal direction successive sections with a visually perceivable pattern and/or a structure, comprising interrupting said visually perceivable pattern and/or said structure by using strips extending at least in the transverse direction of the laminate.

59. Method for manufacturing laminate usable for encasing substrates and/or is made as a bendable sheet, wherein the laminate is formed by connecting at least two material sheets in a press device by means of a press treatment, comprising feeding at least one of said material sheets as a continuous material web to and/or through said press device, and feeding at least one other of said material sheets to the press device as a separate sheet.

60. The method of claim 59, wherein said separate sheet comprises a so-called decor layer.
